(19) United States
(12) Patent Application Publication
(10) Pub. No.: US 2019/0276679 A1
(43) Pub. Date: Sep. 12, 2019

(54) AQUEOUS COATING COMPOSITIONS FOR BARRIER COATINGS, COATED PACKAGING MATERIAL, AND METHOD

(71) Applicant: Flint Group Packaging Inks North America Holdings LLC, Plymouth, MI (US)

(72) Inventors: Huy The Lai, Norwood, OH (US); Grant Shouldice, Mason, OH (US); Philip David Ernest, Mason, OH (US); Rurou Mai, Mason, OH (US)

(73) Assignee: Flint Group Packaging Inks North America Holdings LLC, Plymouth, MI (US)

(21) Appl. No.: 16/293,155

(22) Filed: Mar. 5, 2019

Related U.S. Application Data
(60) Provisional application No. 62/639,298, filed on Mar. 6, 2018.

(51) Int. Cl. C09D 5/08; C09D 129/06; C09D 139/02; C08J 7/04

(52) U.S. Cl. CPC C09D 5/084; C09D 129/06; C09D 139/02; C08J 7/047; C08J 2435/02; C08J 2429/06; C08J 2439/02; C08J 2429/10; C08J 2367/02

(57) ABSTRACT

An aqueous coating composition and a coated packaging material prepared by applying the aqueous coating composition to packaging material comprise poly(vinyl alcohol-vinyl primary amine), poly(methyl vinyl ether-maleic anhydride), and a Ca⁺⁺ microgranulated bentonite clay. The poly(vinyl alcohol-vinyl primary amine) is about 90-98.5 weight percent and the combined weight of poly(methyl vinyl ether-maleic anhydride) and the Ca⁺⁺ microgranulated bentonite clay is from about 1.5-10 weight percent of the coating formed on the packaging material. The weight ratio of the poly(methyl vinyl ether-maleic anhydride) to the Ca⁺⁺ microgranulated bentonite clay is from about 20:80 to about 80:20. The poly(methyl vinyl ether-maleic anhydride) is at least 0.8 weight percent of the coating formed on the packaging material and/or has a weight average molecular weight of at least about 1,000,000 Daltons. The applied coating composition is dried at a temperature of up to about 50° C. to form the coated packaging material. The coating is ink-receptive and has an oxygen transmission rate of up to 0.71 cm³/100 in²/24 hr and a moisture vapor transmission rate of up to about 2.2 g/m²/24 hr.

### CROSS REFERENCE TO RELATED APPLICATION

This application is a non-provisional patent application claiming benefit of U.S. provisional application No. 62/639,298 filed Mar. 6, 2018, which is hereby incorporated by reference in its entirety.

### FIELD OF THE INVENTION

The present invention relates to barrier coatings for packaging, methods for applying barrier coatings on packaging such as flexible packaging films and printing on the coatings, and coated packaging.

### INTRODUCTION TO THE DISCLOSURE

This section provides information helpful in understanding the invention but that is not necessarily prior art.

Flexible packaging is made with a wide variety of materials, including various plastic films, laminates, and foils that are used to extend the shelf life of and protect package contents, such as food products, medicines, chocolate and other candy, pet food, industrial products, and so on. Packaging materials often need to have oxygen barrier properties to protect the packaged contents from oxidation, discoloration, or other undesirable changes to the contents caused by contact with the oxygen in air and/or need to have water vapor barrier properties to protect the packaged contents from moisture or, conversely, to prevent dehydration of the packaged contents due to loss of water through the packaging material. To accomplish this, packaging material may be made with a metal layer (e.g. aluminum foil) or a metal deposited layer to prevent transmission of both oxygen and water vapor through the packaging. Such a metallized system has drawbacks, however, in that the metal layer adds significant cost, changes the tensile and flexural properties of the packaging, and makes the packaging opaque so that the contents cannot be seen through the packaging material.

Plastic films, including laminates with two or more polymer layers, may be coated with a polymeric barrier layer instead of including a metal layer. Polymeric barrier layer compositions that can be applied in a coating layer and which provide gas barrier properties, for example and without limitation oxygen and/or carbon dioxide barrier properties, have been proposed. However, heretofore coatings with acceptable oxygen and/or carbon dioxide barrier properties have not been able to provide adequate barrier properties against transmission of water vapor through the packaging material. Instead, previously used barrier coatings typically experienced degraded barrier properties toward oxygen and carbon dioxide in humid conditions (i.e., in the presence of significant water vapor). Consequently, more than one coating or a combination of coatings and laminate plies acting as multiple barrier layers have been necessary to obtain adequate barrier properties against transmission of oxygen and/or carbon dioxide and water vapor through packaging material.

It is also desirable for the packaging material to be ink-receptive so that decoration, text, barcodes, or other labeling can be printed directly onto the packaging material, and so there is a need for any barrier coating on the packaging material to be ink-receptive. Printing on packaging materials is done by a variety of processes, including, but not limited to, offset lithographic, flexographic, gravure, and digital printing processes.

Bondersma et al, US Patent Application Publication 2011/0159308 describes a layer having improved CO₂ and O₂ barrier properties, the layer comprising a polyvinyl amine-polyvinyl alcohol copolymer that is applied to a substrate in a water-borne composition. The coating formed with the polyvinyl amine-polyvinyl alcohol copolymer can be crosslinked with curing agent reactive toward either the amine or alcohol groups. The barrier layer may include up to 99 wt % of materials other than the polyvinyl amine-polyvinyl alcohol copolymer, including polymers other than the polyvinyl amine-polyvinyl alcohol copolymer and additives other than the curing agent. The Bondersma publication teaches these materials other than the polyvinyl amine-polyvinyl alcohol copolymer are added to improve particular properties of barrier layer performance desired for the particular article being manufactured. Examples of crosslinked barrier films reportedly show increased oxygen transmission rates at high (85%) relative humidity. Bondersma does not mention moisture vapor barrier properties or properties for barrier films that are not crosslinked.

Aoyama et al., US Patent Application Publication 2006/0116471 similarly discloses an aqueous composition containing a (vinyl alcohol)-(vinyl amine) copolymer and a crosslinker reactive with the amino groups of the copolymer. The aqueous coating composition is reported to increase in viscosity between 0.2 and 50 times when held at 60° C. for 3 hours. Aoyama's gas barrier film is crosslinked at a temperature of at least the boiling point of water (i.e., 100° C.) but lower than the melting point of the substrate. For example, the coating is cured during stretching of the polymeric substrate (e.g., at 160° C. for polypropylene or 210-230° C. for PET). Aoyama teaches oxygen barrier properties at high humidity are improved over oxygen barrier properties of earlier coatings due to the crosslinking through the amino groups. One example of the Aoyama aqueous coating composition is prepared with a (vinyl alcohol)-(vinyl amine) copolymer and a (methyl vinyl ether)-(maleic anhydride) copolymer crosslinker (weight average molecular weight of 216,000) in a weight ratio of 150 parts by weight of the (vinyl alcohol)-(vinyl amine) copolymer to 0.98 parts by weight of the (methyl vinyl ether)-(maleic anhydride) copolymer crosslinker and with acetic acid as an adjustor of reaction speed. Aoyama does not mention moisture vapor barrier properties or barrier films that are not crosslinked.

Denny, et al., US Patent Application Publication 2003/0186069 discloses a barrier laminate useful as a barrier against water vapor transmission. The laminate comprises a food contact layer or “skin barrier” of a medium density polyethylene (MDPE); the MDPE is attached by an adhesive tie layer to a polyamide barrier layer. The polyamide barrier layer is in turn attached directly along one surface to an inner paperboard surface. The polyamide layer and adjacent tie layer are said to offer useful oxygen and water vapor barrier properties respectively. The Denny barrier laminate appears to be intended for orange juice cartons made of paperboard. The MDPE is applied at a coating level of about 16 pounds per 3,000 square feet to obtain good moisture barrier properties, high gloss, and an abuse-resistant impact surface; the tie layer and polyamide layer are each applied at a coating level of about 3 to 5 pounds per 3,000 square feet. However, it is desirable to apply much thinner coatings to polymeric packaging films than are applied in the Denny process.

SUMMARY OF THE DISCLOSURE

This section provides a general summary rather than a comprehensive disclosure of the full scope of our invention and of all its features.

We have invented ink-receptive barrier coatings for packaging materials, including but not limited to polymeric films, that provide barrier properties toward atmospheric gases such as oxygen and/or carbon dioxide as well as barrier properties toward water vapor without requiring the high temperatures necessary for crosslinking the coating and without employing metallic layers or laminate layers in the packaging materials. The coating can be formed at temperatures up to about 50° C., for example and without limitation at temperatures from about 20° C. to about 50° C., and provides a surface that is receptive to printing inks. By forming a barrier coating at a low temperature, the invention avoids numerous complications inherent in using coatings that must be crosslinked at high temperatures, including problems caused by undercuring or overcuring the coating; higher energy costs; viscosity increases in the coating compositions before they are applied; and an inability to use certain packaging materials that are not compatible with the high cure temperatures. As distinguished over the earlier barrier coatings described above, the invention provides excellent resistance to transmission of water vapor as well as to transmission of atmospheric gases including, without limitation, oxygen and/or carbon dioxide. Additionally, the coating of our invention provides these exceptional barrier properties even when applied to the packaging at low coating weights.

We disclose an aqueous coating composition that comprises water, poly(vinyl alcohol-vinyl primary amine), poly(methyl vinyl ether-maleic anhydride), and a Ca⁺⁺ microgranulated bentonite clay. The poly(vinyl alcohol-vinyl primary amine) is from about 90 to about 98.5 weight percent of total nonvolatile content of the coating composition and from about 90 to about 98.5 weight percent of the coating (dry coating) formed on the packaging material. The combined weight of poly(methyl vinyl ether-maleic anhydride) and the Ca⁺ microgranulated bentonite clay is from about 1.5 to about 10 weight percent of total nonvolatile content of the coating composition and from about 1.5 to about 10 weight percent of the coating formed on the packaging material. The weight ratio of the poly(methyl vinyl ether-maleic anhydride) to the Ca⁺⁺ microgranulated bentonite clay is from about 20:80 to about 80:20. The poly(methyl vinyl ether-maleic anhydride) is at least 0.8 weight percent of the nonvolatile content of the coating composition and/or has a weight average molecular weight of at least about 1,000,000 Daltons (1000 kDa), for example a weight average molecular weight of from about 1,300,000 to about 1,700,000 Daltons (about 1300 to about 1700 kDa) as determined by gel permeation chromatography (GPC) using a polystyrene calibration curve.

A coated packaging material, for example and without limitation a packaging material that is a polymer film or polymer laminate film, particularly a coated packaging material without any metal layers, is prepared by applying the aqueous coating composition to packaging material and forming a coating therefrom on the packaging material. The aqueous coating composition is dried at temperatures of up to about 50° C., for example from about 20° C. to about 50° C. or from about 30° C. to about 45° C., into a coating on the packaging material. In various embodiments, the coating weight is from about 0.30 to about 0.40 pounds per ream. The coating on the packaging material is ink-receptive, and the coated packaging material may be printed with one or more colors of ink, for example and without limitation in an offset lithographic, flexographic, gravure, or digital printing process, or in a combination of printing processes, to form print on the coated packaging material.

The coated packaging material may be formed into a coated package, into which may be placed contents that need to be protected from oxidation and either hydration (due to ingress of water vapor from the atmosphere) or dehydration (due to egress of water vapor out of the coated package). The coated package provides excellent gas and water vapor barrier properties without requiring high temperatures for the crosslinking that was needed in prior art barrier coatings.

### Definitions

In the case of published test methods, such as ASTM methods, the published test methods cited throughout this document refer the version in effect on the date of filing, whether or not the version number is provided, unless specifically noted otherwise.

“A,” “an,” “the,” “at least one,” and “one or more” are used interchangeably to indicate that at least one of the item is present; a plurality of such items may be present unless the context clearly indicates otherwise. All numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. In addition, disclosure of ranges includes disclosure of all values and further divided ranges within the entire range.

The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. As used in this specification, the term “or” includes any and all combinations of one or more of the associated listed items.

Further areas of applicability will become apparent from the description provided herein. It should be understood that the description and specific examples are intended for purposes of illustration only and are not intended to limit the scope of the present disclosure.

### DETAILED DESCRIPTION

A detailed description including exemplary, nonlimiting embodiments follows.

The aqueous coating composition comprises water, poly(vinyl alcohol-vinyl primary amine), poly(methyl vinyl ether-maleic anhydride), and a Ca⁺⁺ microgranulated bentonite clay. In various embodiments, the nonvolatile material of the aqueous coating composition consists of, or consists essentially of, the poly(vinyl alcohol-vinyl primary amine), the poly(methyl vinyl ether-maleic anhydride), and the Ca⁺⁺ microgranulated bentonite clay. Any additional nonvolatile material other than the poly(vinyl alcohol-vinyl primary amine), the poly(methyl vinyl ether-maleic anhydride), and the Ca⁺⁺ microgranulated bentonite clay does not reduce the oxygen transmission rate or the water vapor transmission rate of a coated packaging material by more than about 5%, preferably by more than 2%, and particularly preferably by more than 1% compared to a coated packaging material prepared without the additional nonvolatile material. It is most preferred that any additional nonvolatile material other than the poly(vinyl alcohol-vinyl primary amine), the poly(methyl vinyl ether-maleic anhydride), and the Ca⁺⁺ microgranulated bentonite clay does not reduce the oxygen transmission rate or the water vapor transmission rate of a coated packaging material. In various embodiments, the poly(vinyl alcohol-vinyl primary amine), the poly(methyl vinyl ether-maleic anhydride), and the Ca⁻⁻ microgranulated bentonite clay nonvolatile material may be at least about 99 percent by weight or at least about 99.5 percent by weight or about 100 percent by weight of the total nonvolatile content of the aqueous coating composition. In certain embodiments, the nonvolatile material of the aqueous coating composition consists only of the poly(vinyl alcohol-vinyl primary amine), the poly(methyl vinyl ether-maleic anhydride), and the Ca⁺⁺ microgranulated bentonite clay.

The poly(vinyl alcohol-vinyl primary amine) may be, for example and without limitation, a copolymer that has a molar percentage of vinyl alcohol units of from about 83 mol % to about 92 mol %, or from about 86 mol % to about 90 mol %, or from about 87 mol % to about 89 mol %, or about 88 mol %. The poly(vinyl alcohol-vinyl primary amine) may have a molar percentage of vinyl primary amine units of from about 8 mol % to about 17 mol %, or from about 10 mol % to about 14 mol %, or from about 11 mol % to about 13 mol %, or about 12 mol %. The poly(vinyl alcohol-vinyl primary amine) may have a weight average molecular weight of from about 10,000 to about 20,000 (determined by gel permeation chromatography using a polyethylene oxide standard of M_{w} 24,000, sample prepared at a concentration of about 10 mg/L in aqueous 0.1 wt % sodium azide); a glass transition of about 85° C. to about 100° C. (as determined by differential scanning calorimetry); and a melting point of about 180° C. to about 230° C. (as determined by differential scanning calorimetry). A 4 wt % aqueous solution of the poly(vinyl alcohol-vinyl primary amine) may have a pH in the range of 9 to 12 and a viscosity at 20° C. of about 5 to about 10 centipoise (as determined according to ASTM D1293).

Copolymers of vinyl primary amine and vinyl alcohol can be prepared by hydrolysis of vinyl carbamate/vinyl acetate copolymers and have been synthesized, for example, by hydrolysis of copolymers of tert-butyl vinyl carbamate with vinyl acetate (C. J. Bloys van Treslong, & B. J. Jansen, “(Vinyl amine)-(vinyl alcohol) copolymers Synthesis, characterization and potentiometric behaviour,” European Polymer Journal, vol. 19, no. 2, pp. 131-34), which is hereby incorporated herein in its entirety U.S. Pat. No. 5,380,403, which is hereby incorporated herein in its entirety, describes synthesis of poly(vinyl alcohol-vinyl primary amine) copolymers, for example, by hydrolysis of vinyl acetate/vinyl amide copolymers. US Patent Applicatin Publication 2008/0112911, which is hereby incorporated herein in its entirety, describes a process for manufacturing a highly water-soluble vinyl alcohol-N-vinyl amine copolymer with a degree of hydrolysis higher than 93% by hydrolysis of a vinyl alcohol-N-vinyl formamide copolymer with an alkaline metal hydroxide in methanol. Suitable copolymers of vinyl amine with vinyl alcohol can also be prepared as described in US Patent Application Publication No. 2011/0159308, which is hereby incorporated herein in its entirety. One suitable poly(vinyl alcohol-vinyl primary amine) copolymer is commercially available from Sekisui Specialty Chemicals America, LLC (Dallas, Tex.) as SELVOL™ Utiloc™ 5003, which has the following properties:

| | |
|---|---|
| Viscosity (4% aqueous | 5-10 cps |
| solution at 20° C., Brookfield) | |
| pH | 9.0-12.0 |
| Appearance | powder white to ivory |
| Melting point | 210-230° C. |

The aqueous coating composition comprises from about 90 to about 98.5 weight percent of the poly(vinyl alcohol-vinyl primary amine), preferably from about 92 to about 98.4 weight percent of the poly(vinyl alcohol-vinyl primary amine), based in each case on total nonvolatile weight of the aqueous coating composition. In other embodiments, the aqueous coating composition comprises from about 90 or from about 90.5 or from about 91 or from about 91.5 or from about 92 or from about 92.5 or from about 93 up to about 93.5 or up to about 94 or up to about 94.5 or up to about 95 or up to about 95.5 or up to about 96 or up to about 96.5 or up to about 97 or up to about 97.5 or up to about 98 or up to about 98.5 weight percent of the poly(vinyl alcohol-vinyl primary amine) based in each case on total nonvolatile weight of the aqueous coating composition. Among other exemplary ranges of the poly(vinyl alcohol-vinyl primary amine) that may be mentioned for the aqueous coating composition are aqueous coating compositions having from about 92 to about 98.5 weight percent, or from about 92 to about 98.4 weight percent, or from about 93 to about 98.4 weight percent, or from about 93.5 to about 98.4 weight percent, or from about 94 to about 98.4 weight percent, or from about 94.5 to about 98.4 weight percent, or from about 95 to about 98.4 weight percent, or from about 95.5 to about 98.4 weight percent, or from about 96 to about 98.4 weight percent, or from about 96.5 to about 98.4 weight percent of the poly(vinyl alcohol-vinyl primary amine), based in each case on total nonvolatile weight of the aqueous coating composition.

Accordingly, the coating formed on the packaging material from the aqueous coating composition comprises from about 90 to about 98.5 weight percent of the poly(vinyl alcohol-vinyl primary amine), preferably from about 92 to about 98.4 weight percent of the poly(vinyl alcohol-vinyl primary amine). In various embodiments, the coating on the packaging material comprises from about 90 or from about 90.5 or from about 91 or from about 91.5 or from about 92 or from about 92.5 or from about 93 up to about 93.5 or up to about 94 or up to about 94.5 or up to about 95 or up to about 95.5 or up to about 96 or up to about 96.5 or up to about 97 or up to about 97.5 or up to about 98 or up to about 98.5 weight percent of the poly(vinyl alcohol-vinyl primary amine). Nonlimiting, exemplary ranges of the poly(vinyl alcohol-vinyl primary amine) in the coating on the packaging material include from about 92 to about 98.5 weight percent, or from about 92 to about 98.4 weight percent, or from about 93 to about 98.4 weight percent, or from about 93.5 to about 98.4 weight percent, or from about 94 to about 98.4 weight percent, or from about 94.5 to about 98.4 weight percent, or from about 95 to about 98.4 weight percent, or from about 95.5 to about 98.4 weight percent, or from about 96 to about 98.4 weight percent, or from about 96.5 to about 98.4 weight percent of the poly(vinyl alcohol-vinyl primary amine).

The poly(methyl vinyl ether-maleic anhydride) and the Ca⁺⁺ microgranulated bentonite clay combined are from about 1.5 to about 10 weight percent of the total nonvolatile weight of the aqueous coating composition. In various exemplary, nonlimiting embodiments, the poly(methyl vinyl ether-maleic anhydride) and the Ca⁺⁺ microgranulated bentonite clay combined are from about 1.5 or from about 1.6 or from about 1.8 or from about 2.0 or from about 2.5 or from about 3 or from about 3.5 or from about 4 or from about 4.5 or from about 5 up to about 5.5 or up to about 6 or up to about 6.5 or up to about 7 or up to about 7.5 or up to about 8 or up to about 8.5 or up to about 9 or up to about 9.5 or up to about 10 weight percent of the total nonvolatile weight of the aqueous coating composition. Nonlimiting, examples include aqueous coating compositions including the poly(methyl vinyl ether-maleic anhydride) and the Ca⁻⁻ microgranulated bentonite clay combined in amounts of from about 1.5 to about 6, or from about 1.5 to about 5.5, or from about 1.5 to about 5, or from about 1.5 to about 4.5, or from about 1.5 to about 4, or from about 1.5 to about 3.5, or from about 1.5 to about 3.2, or from about 1.6 to about 6, or from about 1.6 to about 5.5, or from about 1.6 to about 5, or from about 1.6 to about 4.5, or from about 1.6 to about 4, or from about 1.6 to about 3.5, or from about 1.6 to about 3.2 weight percent of the total nonvolatile weight of the aqueous coating composition.

Accordingly, the coating formed on the packaging material from the aqueous coating composition comprises the poly(methyl vinyl ether-maleic anhydride) and the Ca⁺⁺ microgranulated bentonite clay combined in an amount from about 1.5 to about 10 weight percent of the total nonvolatile weight. In various exemplary, nonlimiting embodiments, the poly(methyl vinyl ether-maleic anhydride) and the Ca⁺⁺ microgranulated bentonite clay combined are from about 1.5 or from about 1.6 or from about 1.8 or from about 2.0 or from about 2.5 or from about 3 or from about 3.5 or from about 4 or from about 4.5 or from about 5 up to about 5.5 or up to about 6 or up to about 6.5 or up to about 7 or up to about 7.5 or up to about 8 or up to about 8.5 or up to about 9 or up to about 9.5 or up to about 10 weight percent of the coating formed on the packaging material. Nonlimiting, examples include the poly(methyl vinyl ether-maleic anhydride) and the Ca⁻⁻ microgranulated bentonite clay combined in amounts of from about 1.5 to about 6, or from about 1.5 to about 5.5, or from about 1.5 to about 5, or from about 1.5 to about 4.5, or from about 1.5 to about 4, or from about 1.5 to about 3.5, or from about 1.5 to about 3.2, or from about 1.6 to about 6, or from about 1.6 to about 5.5, or from about 1.6 to about 5, or from about 1.6 to about 4.5, or from about 1.6 to about 4, or from about 1.6 to about 3.5, or from about 1.6 to about 3.2 weight percent of the coating formed on the packaging material.

The poly(methyl vinyl ether-maleic anhydride) may be at least 0.8 weight percent of the nonvolatile content of the aqueous coating composition and at least 0.8 weight percent of the coating formed on the packaging material, and/or the poly(methyl vinyl ether-maleic anhydride) may have a weight average molecular weight of at least about 1,000,000 Daltons, particularly from about 1,300,000 to about 1,700,000 Daltons as determined by gel permeation chromatography using a polystyrene calibration curve. In particular embodiments, the poly(methyl vinyl ether-maleic anhydride) may be at least 0.8 or at least about 0.9 or at least about 1 or at least about 1.2 or at least about 1.4 or at least about 1.6 or at least about 1.8 or at least about 2 weight percent of the nonvolatile content of the aqueous coating composition or of the coating formed on the packaging material. In various nonlimiting, exemplary embodiments, the poly(methyl vinyl ether-maleic anhydride) may be at least 0.8 weight percent of the nonvolatile content of the aqueous coating composition and of the coating formed on the packaging material and up to about 3 or up to about 2.5 or up to about 2 or up to about 1.9 or up to about 1.8 or up to about 1.7 or up to about 1.6 or up to about 1.5 or up to about 1.4 or up to about 1.3 or up to about 1.1 weight percent of the nonvolatile content of the aqueous coating composition and of the coating formed on the packaging material. Also in particular nonlimiting embodiments, the poly(methyl vinyl ether-maleic anhydride) may have a weight average molecular weight of from about 1,000,000 Daltons up to about 1,800,000 Daltons, or from about 1,000,000 Daltons up to about 1,700,000 Daltons, or from about 1,000,000 Daltons up to about 1,600,000 Daltons, or from about 1,100,000 Daltons up to about 1,800,000 Daltons, or from about 1,100,000 Daltons up to about 1,700,000 Daltons, or from about 1,100,000 Daltons up to about 1,600,000 Daltons, or from about 1,200,000 Daltons up to about 1,800,000 Daltons, or from about 1,200,000 Daltons up to about 1,700,000 Daltons, or from about 1,200,000 Daltons up to about 1,600,000 Daltons, or from about 1,300,000 Daltons up to about 1,800,000 Daltons, or from about 1,300,000 Daltons up to about 1,700,000 Daltons, or from about 1,300,000 Daltons up to about 1,600,000 Daltons, or from about 1,400,000 Daltons up to about 1,800,000 Daltons, or from about 1,400,000 Daltons up to about 1,700,000 Daltons, or from about 1,400,000 Daltons up to about 1,600,000 Daltons, as determined by gel permeation chromatography using a polystyrene calibration curve.

The poly(methyl vinyl ether-maleic anhydride) copolymer may be prepared by straightforward polymerization of methyl vinyl ether and maleic anhydride, for example using one of the methods or prior art methods described in Kittrell et al, U.S. Pat. No. 5,189,122 or Pelah et al., U.S. Pat. No. 5,047,490. In general, the copolymer has about 50 mole % of methyl vinyl ether units and about 50 mole % of maleic anhydride units and can be characterized as an alternating copolymer. Suitable poly(methyl vinyl ether-maleic anhydride) copolymers are commercially available. One suitable example available from Ashland (Columbus, Ohio) is Gantrez™ S-97 HSU SOLUTION polymer, which has the following properties.

| | |
|---|---|
| pH | 1.5-2.5 |
| Density | 1.05 g/cm³ (25° C.) |
| Weight average molecular | about 1,455,000* |
| weight | |

*Determined using an Agilent 1260 Infinity II GPC system (with G7110B pump; G7129A authosampler; G7116A column heater; G7162A refractive index detector; G1364C fraction collector). The sample was prepared at 1 wt % in solvent (80:18:2 tetrahydrofuran:methanol:triethylamine) and analyzed using a polystyrene calibration curve in the range of 135 to 3,500,000 Daltons.

The weight ratio of the poly(methyl vinyl ether-maleic anhydride) to the Ca⁺⁺ microgranulated bentonite clay, both in the aqueous coating composition and in the coating formed on the packaging material, is from about 20:80 to about 80:20. In various nonlimiting exemplary embodiments the weight ratio of the poly(methyl vinyl ether-maleic anhydride) to the Ca⁺⁺ microgranulated bentonite clay may be from about 25:75 to about 80:20, or from about 20:80 to about 75:25, or from about 30:70 to about 80:20, or from about 20:80 to about 70:30, or from about 35:65 to about 80:20, or from about 20:80 to about 65:35, or from about 40:60 to about 80:20, or from about 20:80 to about 60:40, or from about 45:55 to about 80:20, or from about 20:80 to about 55:45, or from about 25:75 to about 75:25, or from about 30:70 to about 75:25, or from about 25:75 to about 70:30, or from about 35:65 to about 75:25, or from about 25:75 to about 65:35, or from about 40:60 to about 75:25, or from about 25:75 to about 60:40, or from about 45:55 to about 75:25, or from about 25:75 to about 55:45, or from about 30:70 to about 70:30, or from about 35:65 to about 70:30, or from about 30:70 to about 65:35, or from about 40:60 to about 70:30, or from about 30:70 to about 60:40, or from about 45:55 to about 70:30, or from about 30:70 to about 55:45, or from about 35:65 to about 65:35, or from about 35:65 to about 60:40, or from about 40:60 to about 65:35, or from about 35:65 to about 55:45, or from about 45:55 to about 65:35, or from about 40:60 to about 60:40, or from about 40:60 to about 55:45, or from about 45:55 to about 60:40, or from about 45:55 to about 55:45.

The Ca⁺⁺ microgranulated bentonite clay has an average particle size less than about 10,000 nm, measured by laser diffraction according to ISO13320:2009. In certain nonlimiting, exemplary embodiments, the Ca⁺⁺ microgranulated bentonite clay has an average particle size of from about 1000 nm to about 10,000 nm, or from about 2000 nm to about 9000 nm, or from about 3000 nm to about 5000 nm. The calcium cation causes the phyllosilicate sheets to be arranged as tetrahedral-octahedral-tetrahedral sheets, which is non-swelling in an aqueous environment. One suitable commercial example of Ca⁺⁺ microgranulated bentonite clay is CLOISITE CA⁺⁺, which is a microgranulated bentonite clay available from BYK-Chemie GmbH, Wesel, Germany and which has the following properties.

| | |
|---|---|
| Moisture | 4-9% |
| Dry particle size | <10 μm (d₅₀) |
| Color | Off-white |
| Density | 2.8 g/cm³ |
| X-ray results | d₀₀₁ = 1.5 nm |

In various nonlimiting, exemplary embodiments of the aqueous coating composition, the Ca⁺⁺ microgranulated bentonite clay may be from about 0.72 to about 1.76 weight percent, or from about 0.75 to about 1.70 weight percent, or from about 0.8 to about 1.6 weight percent of the nonvolatile content of the aqueous coating composition. In other particular nonlimiting embodiments, the Ca⁺⁺ microgranulated bentonite clay may be at least 0.8 weight percent, or at least about 0.9 weight percent, or at least about 1 weight percent, or at least about 1.2 weight percent, or at least about 1.4 weight percent, or at least about 1.6 weight percent, or at least about 1.8 weight percent, or at least about 2 weight percent of the nonvolatile content of the aqueous coating composition and up to about 3 weight percent of the nonvolatile content of the aqueous coating composition. In still further embodiments, the Ca⁺⁺ microgranulated bentonite clay may be at least 0.8 weight percent of the nonvolatile content of the aqueous coating composition and up to about 3 weight percent, or up to about 2.5 weight percent, or up to about 2 weight percent, or up to about 1.9 weight percent, or up to about 1.8 weight percent, or up to about 1.7 weight percent, or up to about 1.6 weight percent, or up to about 1.5 weight percent, or up to about 1.4 weight percent, or up to about 1.3 weight percent, or up to about 1.1 weight percent of the nonvolatile content of the aqueous coating composition.

In exemplary, nonlimiting embodiments, when the aqueous coating is applied and forms the coating on the packaging material, the Ca⁺⁺ microgranulated bentonite clay may be from about 0.72 to about 1.76 weight percent, or from about 0.75 to about 1.70 weight percent, or from about 0.8 to about 1.6 weight percent of the coating formed on the packaging material. In other particular nonlimiting embodiments, the Ca⁺⁺ microgranulated bentonite clay may be at least 0.8 weight percent, or at least about 0.9 weight percent, or at least about 1 weight percent, or at least about 1.2 weight percent, or at least about 1.4 weight percent, or at least about 1.6 weight percent, or at least about 1.8 weight percent, or at least about 2 weight percent of the coating formed on the packaging material and up to about 3 weight percent of the coating formed on the packaging material. In still further embodiments, the Ca⁺⁺ microgranulated bentonite clay may be at least 0.8 weight percent of the nonvolatile content of the coating formed on the packaging material and up to about 3 weight percent, or up to about 2.5 weight percent, or up to about 2 weight percent, or up to about 1.9 weight percent, or up to about 1.8 weight percent, or up to about 1.7 weight percent, or up to about 1.6 weight percent, or up to about 1.5 weight percent, or up to about 1.4 weight percent, or up to about 1.3 weight percent, or up to about 1.1 weight percent of the coating formed on the packaging material.

The aqueous coating composition further comprises water. While not wishing to be bound by theory, when combined in the aqueous liquid coating composition, the anhydride group of the poly(methyl vinyl ether-maleic anhydride) copolymer hydrolyzes to a maleic acid group and is believed to ionically interact with the amine group of the poly(vinyl alcohol-vinyl primary amine) copolymer.

In various nonlimiting examples, the aqueous coating composition has a nonvolatile content of from about 11.2 wt % to about 13 wt %, preferably from about 11.4 wt % to about 12.8 wt %, or from about 11.5 wt % to about 12.4 wt % as measured according to ASTM D2369. The aqueous coating composition may be formulated to have an appropriate viscosity for application by the selected process, which may be chosen by considering factors known in the art, for example type of packaging material and desired coating thickness on the packaging material. In certain nonlimiting embodiments, the aqueous coating composition has a viscosity of from about 12 seconds to about 16 seconds, preferably from about 13 seconds to about 15 seconds, measured using an EZ Zahn 3 cup according to ASTMD4212-99.

The aqueous coating composition may optionally include a small amount of additives, so long as the additives do not detract from ability of the aqueous coating composition to form an ink-receptive coating on the packaging material and do not detract from the barrier properties of the coating formed on the packaging material. The aqueous coating composition may optionally include one or more water-soluble organic cosolvents, for example acetone, methyl ethyl ketone, and C1-C3 alcohols and their monoalkyl ethers and monoalkyl ether esters, such as ethylene glycol and propylene glycol monoalkyl ethers and monoalkyl ether acetates and propionates. The aqueous coating composition may optionally include one wetting agents and/or defoamers. Suitable examples of wetting agents and defoamers include, without limitation, polyoxyalkylenes, block or graft copolymers of polyoxyethylene with a more hydrophobic material, paraffin oils, salts of fatty acids, salts of dialkyl-sulfosuccinic acid, salts of alkyl and aryl sulfonates, polyoxyethylene alkyl ethers, acetylene diols and their derivatives, copolymers of polyoxyethylene and polyoxypropylene, alcohol alkoxylates, alkylamines, quaternary ammonium salts, and betaines. In certain embodiments, the additive or additives are preferably nonionic or amphoteric. Many suitable wetting agents and defoamers are commercially available, including without limitation METOLAT® 780, METOLAT® 775, and METOLAT® 750, AGITAN® 5149, AGITAN® 100, AGITAN® 351, and DEE FO® 215, all available from MÜNZING North America (Bloomfield, N.J.), and SUFYNOL® 420, available from Evonik Corporation (Allentown, Pa.). Other additives that may be useful in the liquid coating composition include, without limitation, dyes, biocides, and waxes. The aqueous coating composition may include up to about 10 wt % additives. In exemplary, nonlimiting embodiments, the aqueous coating composition includes from about 0.05 to about 5 wt % additives, or from about 0.1 to about 3 wt % additives, or from about 0.1 to about 2 wt % additives. The aqueous coating composition is preferably free of heavy metals.

The aqueous coating composition is applied in a layer onto a packaging material. The packaging material is not particularly limited, and any packaging material that may receive the aqueous coating composition and on which the coating may be formed may be used. Examples of suitable packaging material include, without limitation, polyethylene terephthalate (PET) and treated PET, oriented polypropropylene, biaxially oriented polypropylene, polyamides, poly(vinylidene chloride), acrylics, biaxially oriented polyurethanes, and ethylene vinyl acetate copolymers, which may be in the form of film or board, and laminates prepared with layers of these materials. The packaging material may be, and preferably are, free of metallized layers. The thickness of a packaging material may be any thickness desirably used for forming packages for the target contents. The applied coating layer dries to form a coating on the packaging material.

The aqueous coating composition may be applied by any method suitable for applying aqueous coating compositions to the selected packaging material. In general, suitable application methods include, without limitation, spreading, spraying, dipping, rolling or application with a roller blade, bar coating, knife coating, coating with wire-wound doctor bars, air brushes, reverse-roll application processes, reverse gravure coating, and curtain coating. The application method depends to an extent on the type and form of packaging material selected. When packaging materials in web form are used, the aqueous coating composition can be applied from a trough by way of an applicator roll and leveled with the aid of an air brush. For example and without limitation, coating composition may be applied at to the surface of a web of packaging material at a speed of 50 m/min to 220 m/min.

The applied aqueous coating composition layer is then dried to form the coated packaging material. Among suitable drying methods, the applied aqueous coating composition layer may be dried with heated air, infrared heating, or both. For example, in the case of continuous operation to pass the material through a drying tunnel which can have been equipped with an infrared irradiation device. The coating can be formed at temperatures from ambient up to about 50° C., for example and without limitation at temperatures from about 20° C. to about 50° C., or from about 25° C. to about 45° C., from about 30° C. to about 45° C., or from about 30° C. to about 40° C., or from about 35° C. to about 45° C. In a nonlimiting example, the drying time may be from about 1 second to about 120 seconds. Once dried, the coating weight may be from about 0.30 to about 0.40 pounds per ream.

The coating layer on the package thus should be thermoplastic. In particular, the coating layer is preferably not covalently crosslinked by reaction of the poly(vinyl alcohol-vinyl primary amine) copolymer and the poly(methyl vinyl ether-maleic anhydride) copolymer.

In various embodiments, the coated packaging film with the barrier coating has an oxygen transmission rate of from 0 up to 0.71 cm³/100 in²/24 hr as measured according to ASTM F-1927 and a moisture vapor transmission rate of from 0 up to about 2.2 g/m²/24 hr as measured according to ASTM F-1249. Among these are embodiments in which the coated packaging film has an oxygen transmission rate of from 0 up to 0.7 cm³/100 in²/24 hr as measured according to ASTM F-1927 and a moisture vapor transmission rate of from 0 up to about 2.0 g/m²/24 hr or up to about 1.5 g/m²/24 hr or up to about 1.0 g/m²/24 hr as measured according to ASTM F-1249.

The coating is ink-receptive, and it is therefore not necessary to overcoat the coated substrates with outer layers to be able to print on the surface of the coated packaging film. The coated packaging material may be printed with one or more colors of ink to form print on the coated packaging material. The one or more inks can be applied to the coating layer on the coated packaging material by any suitable printing method, including gravure printing, rotogravure printing, ink jet printing, silk screen printing, flexographic printing, lithographic printing, electrophotographic printing, intaglio printing, pad printing, and so on. In a nonlimiting example, a printing ink or printing inks may be applied to the coated packaging material in a flexographic or gravure (such as rotogravure) printing process.

Nonlimiting examples of suitable printing inks that may be used include solvent based inks such as nitrocellulose modified inks, polyurethane inks, polyvinylchloride based inks, polyamide based inks and polyvinyl butyral based inks; water based inks such as acrylic polymer based inks, rosin maleic polymer based inks, protein based inks and acrylic modified inks; and 100% solids inks such as ultraviolet (UV) cured acrylate inks, UV cured cationic inks, electron beam (EB) cured inks, and non-acrylate UV cured inks.

Before or after being printed, the coated packaging material may be formed into a package, particularly a package into which contents that are advantageously protected from oxygen and/or carbon dioxide or that are advantageously protected against ingress or egress of water vapor (in other words, that must be kept either anhydrous or hydrated). Examples of such contents include food products, medicines, chocolate and other candy, pet food, and hygroscopic chemicals.

The invention is further described in the following examples. The example is merely illustrative and does not in any way limit the scope of the invention as described and claimed. All parts are parts by weight unless otherwise noted.

### EXAMPLES

Preparation A.

A vessel is charged with 80 grams of water at room temperature. With vigorous stirring, 0.2 gram of Metolat® 780 (non-ionic surfactant available from Münzing Chemie, Bloomfield, N.J.) is added, followed by 20 grams of SELVOL™ Utiloc™ 5003 (a poly(vinyl alcohol-vinyl primary amine) polymer, available from Sekisui Specialty Chemicals America, LLC, Dallas, Tex.) to form an aqueous mixture. Continuing the vigorous stirring, the aqueous mixture is then heated to 85° C. to 95° C. and held at that temperature for about 30 minutes to form Preparation A. Preparation A is 18% nonvolatile by weight as measured by ASTM D2369.

Metolat® 780 is a liquid with a density of 7.85 lbs/gal; a surface tension (Wilhelmy Plate; 0.1 wt % in DI water) of 26.7 mN/m; an HLB (Griffith method) of 9; and a viscosity at 25° C. of 20 to 120 centipoise.

Preparation B.

A vessel is charged with 80 grams of water at room temperature. With stiring, 20 grams of ammonia solution (26 wt % ammonium hydroxide in water) is added to the water to form an ammonia mixture. A 30-gram portion of the ammonia mixture is charged to a clean vessel, then 10 grams of Gantrez™ S-97 HSU SOLUTION polymer (an aqueous solution of a copolymer of methyl vinyl ether and maleic anhydride, available from Ashland, Columbus, Ohio) is added with agitation. Slow agitation is continued at room temperature for about 10 minutes to form Preparation B. Preparation B is 5% nonvolatile by weight as measured by ASTM D2369.

Preparation C.

A vessel is charged with 95 grams of water at room temperature. With agitation, 5 grams of CLOISITE CA⁺⁺ (a Ca⁺⁺ microgranulated bentonite clay available from BYK-Chemie GmbH, Wesel, Germany) is added. Agitation is continued until the CLOISITE CA⁺⁺ is dispersed, forming Preparation C. Preparation C is 5% nonvolatile by weight as measured by ASTM D2369.

### Preparation Examples 1-33. Liquid Coating Compositions According to the Invention

### Examples 1-33

Aqueous coating compositions were prepared by combining materials as shown in Table 1. Amounts are given in parts by weight (pbw).

TABLE 1

| | | | Prep- | | |
|---|---|---|---|---|---|
| | Preparation | Preparation | aration | Metolat ® | Water |
| Example | A (pbw) | B (pbw) | C (pbw) | 780 (pbw) | (pbw) |
| 1 | 16.7 | 2 | 2 | 0.1 | 5.5 |
| 2 | 33.3 | 2 | 2 | 0.1 | 13.5 |
| 3 | 50 | 2 | 2 | 0.1 | 21.5 |
| 4 | 66.7 | 2 | 2 | 0.1 | 30 |
| 5 | 16.7 | 6 | 2 | 0.1 | 3.2 |
| 6 | 33.3 | 6 | 2 | 0.1 | 11.5 |
| 7 | 50 | 6 | 2 | 0.1 | 19 |
| 8 | 66.7 | 6 | 2 | 0.1 | 27 |
| 9* | 16.7 | 14 | 2 | 0.1 | 0 |
| 10 | 33.3 | 14 | 2 | 0.1 | 9.5 |
| 11 | 50 | 14 | 2 | 0.1 | 19 |
| 12 | 66.7 | 14 | 2 | 0.1 | 28 |
| 13* | 16.7 | 20 | 2 | 0.1 | 0 |
| 14 | 33.3 | 20 | 2 | 0.1 | 3.5 |
| 15 | 50 | 20 | 2 | 0.1 | 12 |
| 16 | 66.7 | 20 | 2 | 0.1 | 19 |
| 17* | 16.7 | 2 | 6 | 0.1 | 4 |
| 18 | 33.3 | 2 | 6 | 0.1 | 13 |
| 19 | 50 | 2 | 6 | 0.1 | 21.5 |
| 20 | 66.7 | 2 | 6 | 0.1 | 30 |
| 21 | 16.7 | 6 | 6 | 0.1 | 1.5 |
| 22 | 33.3 | 6 | 6 | 0.1 | 10 |
| 23 | 50 | 6 | 6 | 0.1 | 19 |
| 24 | 66.7 | 6 | 6 | 0.1 | 27 |
| 25* | 16.7 | 14 | 6 | 0.1 | 0 |
| 26 | 33.3 | 14 | 6 | 0.1 | 5 |
| 27 | 50 | 14 | 6 | 0.1 | 14 |
| 28 | 66.7 | 14 | 6 | 0.1 | 23 |
| 29* | 16.7 | 20 | 6 | 0.1 | 0 |
| 30 | 33.3 | 20 | 6 | 0.1 | 2 |
| 31 | 50 | 20 | 6 | 0.1 | 11 |
| 32 | 66.7 | 20 | 6 | 0.1 | 19 |
| 33 | 65.0 | — | — | — | 35 |

*Coating composition gels over time.

### Examples 34-66

Coated packaging material was prepared by applying the liquid coating compositions of Examples 1-32 to 48-gauge corona-treated polyethylene terephthalate (PET) film (obtained from Toray Plastics). Each liquid coating compositions of Examples 1-32 was reduced to an application viscosity measured with an EZ Zahn #3 cup of 12-16 seconds (as measured according to ASTM D4212-99), then applied to the 48-gauge corona-treated polyethylene terephthalate film using a 220 lpi/7.1 bcm anilox handproofer. After application of the liquid coating composition, coating was dried with a 12-amp Master Heatgun for 5 seconds (peak temperature less than 50° C.).

Examples 1-4, 7, 8, 18-20, 23, 24, 27, 28, and 32 are examples of the invention. Examples 5, 6, 9-17, 21, 22, 25, 26, 29-31 and 33 are comparative examples.

The coated PET film was then tested for oxygen transmission rate (OTR) and for moisture vapor transmission rate (MVTR) using a sample four inches by four inches. The results are reported in Table 2. Oxygen transmission rate was measured according to ASTM F-1927 (version current on Jun. 1, 2017) with a MOCON Oxtran 2/21 Oxygen Permeability Instrument under these test conditions:
Test gas: Oxygen
Test gas concentration: 100%
Test gas relative humidity: 50%
Test gas pressure: 760 mm Hg

Test temperature: 23.0° C.
Carrier gas: 98% N₂, 2% H₂
Carrier gas relative humidity: 0%
Sample area: 50 cm²
Moisture vapor transmission rate was measured according to ASTM F-1249 (version current on Jun. 1, 2017) with a MOCON Permatran-W 3/33 Water Vapor Permeability Instrument under these test conditions
Test gas: Water vapor
Test gas relative humidity: 90%
Test gas pressure: 760 mm Hg
Test temperature: 38.0° C.
Carrier gas: Nitrogen
Carrier gas relative humidity: 0%
Sample area: 50 cm²

TABLE 2

| | | poly(vinyl | copolymer of | | | | |
|---|---|---|---|---|---|---|---|
| | | alcohol-vinyl | methyl vinyl | Ca⁺⁺ | | | |
| | | primary amine) | ether and | microgranulated | Liquid | | |
| | Liquid | polymer, parts | maleic anhydride, | bentonite clay, | coating | | |
| | Coating | by weight (solid | parts by weight | parts by weight | composition | | |
| | Composition | weight on weight | (solid weight on | (solid weight on | wt % | OTR | MVTR |
| Example | Example | total solids) | weight total solids) | weight total solids) | nonvolatile | (cm³/100 in²/24 hr) | (g/m²/24 hr) |
| 34 | 1 | 93.8 | 3.1 | 3.1 | 12.23 | 0.22 | 0.9302 |
| 35 | 2 | 96.8 | 1.6 | 1.6 | 12.20 | 0.128 | 0.9570 |
| 36 | 3 | 97.8 | 1.1 | 1.1 | 12.19 | 0.697 | 0.8774 |
| 37 | 4 | 98.4 | 0.8 | 0.8 | 12.12 | 0.509 | 0.8700 |
| 38 | 5 | 88.2 | 8.8 | 2.9 | 12.20 | 0.136 | 3.0330 |
| 39 | 6 | 93.8 | 4.7 | 1.6 | 12.11 | 0.220 | 2.9406 |
| 40 | 7 | 95.7 | 3.2 | 1.1 | 12.21 | 0.068 | 2.2046 |
| 41 | 8 | 96.8 | 2.4 | 0.8 | 12.20 | 0.046 | 1.9684 |
| 42 | 9 | 78.9 | 18.4 | 2.6 | 11.63 | 0.223 | 3.9642 |
| 43 | 10 | 88.2 | 10.3 | 1.5 | 11.56 | 0.185 | 3.6624 |
| 44 | 11 | 91.8 | 7.1 | 1.0 | 11.53 | 0.071 | 2.5518 |
| 45 | 12 | 93.8 | 5.5 | 0.8 | 11.57 | 0.074 | 2.2706 |
| 46 | 13 | 73.2 | 24.4 | 2.4 | 10.60 | 0.440 | 3.8376 |
| 47 | 14 | 84.5 | 14.1 | 1.4 | 12.07 | 0.145 | 3.5902 |
| 48 | 15 | 89.1 | 9.9 | 1.0 | 12.02 | 0.237 | 3.4821 |
| 49 | 16 | 91.6 | 7.6 | 0.8 | 12.17 | 0.164 | 3.6731 |
| 50 | 17 | 88.2 | 2.9 | 8.8 | 11.86 | 0.442 | 2.4294 |
| 51 | 18 | 93.8 | 1.6 | 4.7 | 11.78 | 0.401 | 2.2294 |
| 52 | 19 | 95.7 | 1.1 | 3.2 | 11.82 | 0.377 | 1.9325 |
| 53 | 20 | 96.8 | 0.8 | 2.4 | 11.85 | 0.268 | 1.5037 |
| 54 | 21 | 83.3 | 8.3 | 8.3 | 11.93 | 0.710 | 4.5120 |
| 55¹ | 22 | 90.9 | 4.5 | 4.5 | 11.93 | 0.475 | 3.1549 |
| 56 | 23 | 93.8 | 3.1 | 3.1 | 11.85 | 0.367 | 1.6638 |
| 57 | 24 | 95.2 | 2.4 | 2.4 | 11.92 | 0.301 | 1.2884 |
| 58 | 25 | 75.0 | 17.5 | 7.5 | 10.91 | 0.831 | 4.9550 |
| 59 | 26 | 85.7 | 10.0 | 4.3 | 12.00 | 0.499 | 2.2943 |
| 60 | 27 | 90.0 | 7.0 | 3.0 | 11.90 | 0.411 | 1.4336 |
| 61 | 28 | 92.3 | 5.4 | 2.3 | 11.85 | 0.401 | 1.3672 |
| 62 | 29 | 69.8 | 23.3 | 7.0 | 10.08 | 0.918 | 4.4919 |
| 63 | 30 | 82.2 | 13.7 | 4.1 | 11.90 | 0.909 | 3.8873 |
| 64 | 31 | 87.4 | 9.7 | 2.9 | 11.84 | 0.711 | 2.0255 |
| 65 | 32 | 90.2 | 7.5 | 2.3 | 11.91 | 0.549 | 2.1011 |
| 66 | 33 | 100 | 0 | 0 | 11.70 | 0.216 | 3.4919 |

¹Repetition of Example 55 confirmed that the coating originally tested had a defect. Repeat testing gave MVTR values in the range of 0.7-0.9 g/m²/24 hr

Examples 34-37, 40, 41, 51-53, 56, 57, 60, 61, and 65 are examples of the invention; examples 38, 42-50, 54, 58, 59, 62-64, and 66 are comparative examples. The results of the testing demonstrate that coated PET film made according to the invention has both unexpectedly excellent resistance to oxygen transmission and unexpectedly excellent resistance to water vapor transmission.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A method of making a coated packaging material, comprising:
applying onto a surface of a packaging material an aqueous coating composition comprising water, poly(vinyl alcohol-vinyl primary amine), poly(methyl vinyl ether-maleic anhydride), and a Ca⁺⁺ microgranulated bentonite clay, wherein the poly(vinyl alcohol-vinyl primary amine) is from about 90 to about 98.5 weight percent of total nonvolatile weight of the aqueous coating composition, wherein the combined weight of poly(methyl vinyl ether-maleic anhydride) and the Ca⁺⁺ microgranulated bentonite clay is from about 1.5 to about 10 weight percent of nonvolatile content of the aqueous coating composition, wherein the weight ratio of the poly(methyl vinyl ether-maleic anhydride) to the Ca⁺⁺ microgranulated bentonite clay is from about 20:80 to about 80:20, and wherein the poly(methyl vinyl ether-maleic anhydride) is at least 0.8 weight percent of the nonvolatile content of the aqueous coating composition and/or has a weight average molecular weight of at least about 1,000,000 Daltons; drying the applied aqueous coating composition at a temperature of up to about 50° C. to form the coated packaging material.

2. A method according to claim 1, wherein the applied aqueous coating composition is dried at a temperature of from about 20° C. to about 50° C.

3. A coated packaging material made by the method of claim 1.

4. A coated packaging material according to claim 3, wherein the coating is ink-receptive and has an oxygen transmission rate of up to 0.71 cm³/100 in²/24 hr and a moisture vapor transmission rate of up to about 2.2 g/m²/24 hr.

5. A coated packaging material according to claim 3, wherein the packaging material comprises a member selected from the group consisting of polyethylene terephthalates (PET), treated PET, oriented polypropropylenes, biaxially oriented polypropylenes, polyamides, poly(vinylidene chloride), acrylics, biaxially oriented polyurethanes, ethylene vinyl acetate copolymers, and laminates thereof.

6. A packaging formed from the coated packaging material according to claim 3.

7. An aqueous coating composition, comprising:
water, poly(vinyl alcohol-vinyl primary amine), poly(methyl vinyl ether-maleic anhydride), and a Ca⁺⁺ microgranulated bentonite clay,
wherein the poly(vinyl alcohol-vinyl primary amine) is from about 90 to about 98.5 weight percent of total nonvolatile weight of the aqueous coating composition,
wherein the combined weight of poly(methyl vinyl ether-maleic anhydride) and the Ca⁺⁺ microgranulated bentonite clay is from about 1.5 to about 10 weight percent of nonvolatile content of the aqueous coating composition,
wherein the weight ratio of the poly(methyl vinyl ether-maleic anhydride) to the Ca⁺⁺ microgranulated bentonite clay is from about 20:80 to about 80:20, and
wherein the poly(methyl vinyl ether-maleic anhydride) is at least 0.8 weight percent of the nonvolatile content of the aqueous coating composition and/or has a weight average molecular weight of at least about 1,000,000 Daltons.

8. An aqueous coating composition according to claim 7, wherein the total nonvolatile content of the coating composition consists essentially of the poly(vinyl alcohol-vinyl primary amine) copolymer, the poly(methyl vinyl ether-maleic anhydride) copolymer, and the Ca⁺⁺ microgranulated clay.

9. An aqueous coating composition according to claim 7, wherein the weight ratio of the poly(methyl vinyl ether-maleic anhydride) to the Ca⁻⁺ microgranulated bentonite clay is from about 25:75 to about 75:25.

10. An aqueous coating composition according to claim 7, wherein the weight ratio of the poly(methyl vinyl ether-maleic anhydride) to the Ca⁻⁺ microgranulated bentonite clay is from about 30:70 to about 70:30.

11. An aqueous coating composition according to claim 7, wherein the poly(methyl vinyl ether-maleic anhydride) has a weight average molecular weight of from about 1,000,000 to about 2,000,000 Daltons.

12. A packaging material having a coating thereon, wherein the coating comprises poly(vinyl alcohol-vinyl primary amine), poly(methyl vinyl ether-maleic anhydride), and a Ca⁺⁺ microgranulated bentonite clay;
wherein the poly(vinyl alcohol-vinyl primary amine) is from about 90 to about 98.5 weight percent of the coating;
wherein the combined weight of poly(methyl vinyl ether-maleic anhydride) and the Ca⁺⁺ microgranulated bentonite clay is from about 1.5 to about 10 weight percent of the coating;
wherein the weight ratio of the poly(methyl vinyl ether-maleic anhydride) to the Ca⁺⁺ microgranulated bentonite clay is from about 20:80 to about 80:20; and
wherein the poly(methyl vinyl ether-maleic anhydride) either:
(a) is at least 0.8 weight percent of the coating or
(b) has a weight average molecular weight of at least about 1,000,000 Daltons.

13. A packaging material according to claim 12, wherein the packaging material is a polymeric film.

14. A packaging material according to claim 12, wherein the packaging material is polyethylene terephthalate.

15. A packaging material according to claim 12, wherein the poly(methyl vinyl ether-maleic anhydride) is at least 0.8 weight percent of total nonvolatile weight of the coating composition

16. A packaging material according to claim 12, wherein the poly(methyl vinyl ether-maleic anhydride) has a weight average molecular weight of from about 1,000,000 to about 2,000,000.

17. A packaging material according to claim 12, wherein the coating is ink-receptive and has an oxygen transmission rate of up to 0.71 cm³/100 in²/24 hr and a moisture vapor transmission rate of up to about 2.2 g/m²/24 hr.

18. A packaging material according to claim 12, wherein the weight ratio of the poly(methyl vinyl ether-maleic anhydride) to the Ca⁺⁺ microgranulated bentonite clay is from about 25:75 to about 75:25.

19. A packaging material according to claim 12, wherein the coating weight is from about 0.3 to about 0.4 pounds per ream.
